(19) United States
(12) Patent Application Publication
(10) Pub. No.: US 2002/0054122 A1
(43) Pub. Date: May 9, 2002

(54) System and method for the collection of observations, graphical interface therefor and data structure associated therewith

(75) Inventor: Michel A. Lortie, St-Lazare (CA)

Correspondence Address: MERCHANT & GOULD PC, P.O. BOX 2903, MINNEAPOLIS, MN, 55402-0903, US

(73) Assignee: DataCapture.ca Corporation Inc.

(21) Appl. No.: 09/874,860

(22) Filed: Jun. 5, 2001

Related U.S. Application Data
(60) Provisional application No. 60/210,471, filed on Jun. 9, 2000.

(51) Int. Cl. G09G 5/00; G06F 17/24; G06F 17/21; G06F 17/00; G06F 15/00

(52) U.S. Cl. 345/780; 707/507; 345/700

(57) ABSTRACT

A system for the collection of observations is described which has particular application in the clinical research and aerospace industries. The system has a planning station, for preparing a work package of observations to be collected; a download station for downloading the work package to at least one primary capture tool, the primary capture tool being used to collect observations according to the work package autonomously; and an upload station, for uploading the observations from the at least one primary capture tool. The invention also concerns a method for collecting observations, as well as a graphical interface therefor. The invention make use of an atomic database, which obviates the need to reprogram the database when it is to be used for a different set of observations to be collected.

### FIELD OF THE INVENTION

The present invention relates to system and method for the collection of observations, graphical interface therefor and data structure associated therewith. The present invention finds particular use in the pharmaceutical research and aircraft maintenance environments, where observations must be rigorously collected, tabulated and analysed.

### DESCRIPTION OF THE PRIOR ART

The field of data collection based on observation, is one where the accuracy of measurements is critical. Such observations are necessary for conducting for example, research in new drugs or therapies. In such a case, a drug or treatment is administered to a subject. At regular intervals, a person (the observer) observes the subject and notes any observations. These observations are then collected and analysed in order to evaluate the efficiency, side effects, etc. of the drug or treatment.

Such observations are typically presently recorded on a piece of paper by the observer. The observations are subsequently entered on a computer system by an operator, which introduces a degree of error. Such a process is also extremely time consuming.

In an unrelated field, aircrafts are inspected prior to take-off in order to ensure airworthiness. The inspections are performed using a checklist (piece of paper), which also introduces a degree of error.

Although some attempts have been made in order to automate the gathering of observations in the clinical and aerospace industries, none of the solutions proposed have met with commercial success.

### SUMMARY OF THE INVENTION

It is an object of the invention to provide a system and method for the collection of observations which is portable, easy to handle and is more reliable than the prior systems.

In accordance with the invention, this object is achieved with a system for the collection of observations, comprising:

a planning station, for preparing a work package of observations to be collected;

a download station for downloading said work package to at least one primary capture tool, said primary capture tool being used to collect observations according to said work package; and

an upload station, for uploading said observations from said at least one primary capture tool.

In accordance with the invention, this object is also achieved with a method for collecting observations comprising:

downloading an application-specific work package established at a planning station to at least one primary capture tool;

collecting observations with said at least one primary capture tool using a graphical user interface; and

uploading said observations to an upload station.

It is another object of the present invention to provide an atomic data structure for use with the system and method mentioned above which prevents the need for re-programming the database when migrating from one observation task to another. In accordance with another aspect of the invention, this object is achieved with

It is a further object of the present invention to provide a graphical user interface for use with the system and method mentioned above, which minimizes errors during the collection of observations. In accordance with yet another aspect of the invention, this object is achieved with a graphical user interface for use with a primary capture tool to collect observations of a target, said graphical user interface including a graphical representation of said target and a pick list, wherein when said user selects a portion of said graphical representation of said target, a pick list appears, thereby enabling said primary capture tool to collect valid observations and measurements.

### BRIEF DESCRIPTION OF THE DRAWINGS

The present invention and its advantages will be more easily understood after reading the following non-restrictive description of preferred embodiments thereof, made with reference to the following drawings in which:

FIG. 1 is a schematic representation of a system for collecting observations according to a preferred embodiment of the invention;

FIGS. 2a and 2b are schematic representations of the graphical user interface of the finding's review, FIG. 2a shows the GUI prior to finding review and FIG. 2b shows the GUI after finding review;

FIG. 3a is a schematic representation of the GUI and showing the dorsal 3a and ventral 3b navigational views;

FIG. 4a is a schematic representation of the questionnaire as initially presented in FIG. 4a and with the multi-select tool active FIG. 4b;

FIG. 5a is similar to FIG. 4a in that in FIG. 5a, the selected answers are displayed and in FIG. 5b the questionnaire is indicated as being completed and signed;

FIG. 6 is a schematic representation of the architecture of the system of the present invention; and

FIG. 7 is a schematic representation of the structure of the data according to a preferred embodiment of the invention.

### DESCRIPTION OF A PREFERRED EMBODIMENT OF THE INVENTION

While the use of client-server computing for the purpose of data capture within the drug development industry is not new, the system and method according to the present invention introduces several novel elements that together simplify, streamline and improve the overall effectiveness of the automation provided.

These elements include but are not limited to:

The use of hand-held or pocket PCs as the primary capture tool which eliminates the need for tethered operation of the capture computer in the examination room. In the pre-clinical setting, this un-tethered operation reduces the danger of cross contamination of studies caused by the transfer of computer carts from room to room. In the clinical setting, the size and mobility of the device make for greater acceptability by investigators given the limited space in which they operate.

The weight advantage the hardware has over a slate PC or laptop is considerable (250 g vs. 6 to 8 kg). This weight advantage translates into increased user acceptance given that the technician or investigator typically carries the device on his/her person for a full shift (8 hours).

The use of a graphical user interface (GUI) and test system schematics as the primary location mechanism for all observations.

The implementation of a generic or atomic data structure within the primary data store eliminates the need to program a unique structure and capture software for each study. The “atomic” nature of the data store is derived from the fact that the relationship between data elements (meta data) normally held in the table structure of relational databases is converted to data within the AtDB and is held there in exactly the same fashion as the information data. This transformation allows the AtDB to hold virtually any type of measurement or observation without the need of specific to purpose programming.

At an operational level, the use of test system schematics and application-specific lexicons force the capture operators to provide only “valid” observations and measurements. The required meta information (e.g. date/time stamp of captured data, ID of technician and instrument used to capture data as well as confirmation that the technician performing the operation is currently qualified) is all integrally associated to the data record by the primary capture tool. This has important implications for both the quality of the data captured as well as the overall cost of executing studies given that data verification and correction times are drastically reduced over traditional capture methods.

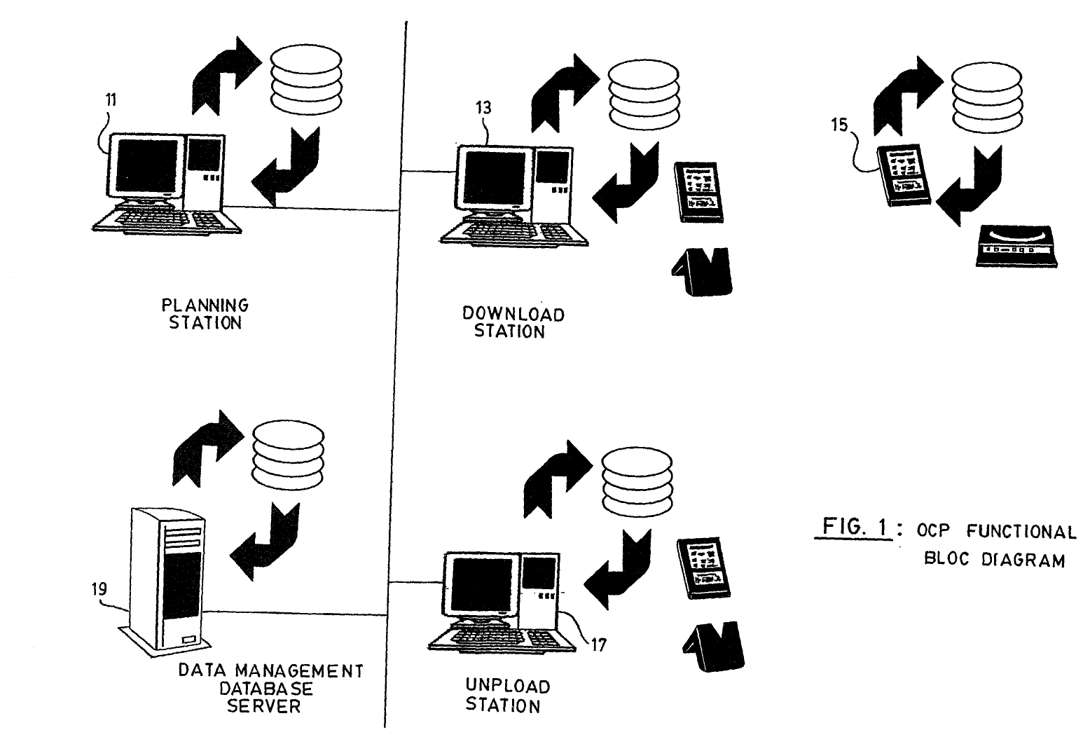

FIG. 1 presents a physical implementation of the system 10 of the present invention based on hand-held PCs and a traditional PC client-server environment. The elements include:

a Planning Station 11;

a Download Station 13;

at least one primary capture tool 15;

an Upload Station 17; and

a Data Management Database Server (AtDB 19);

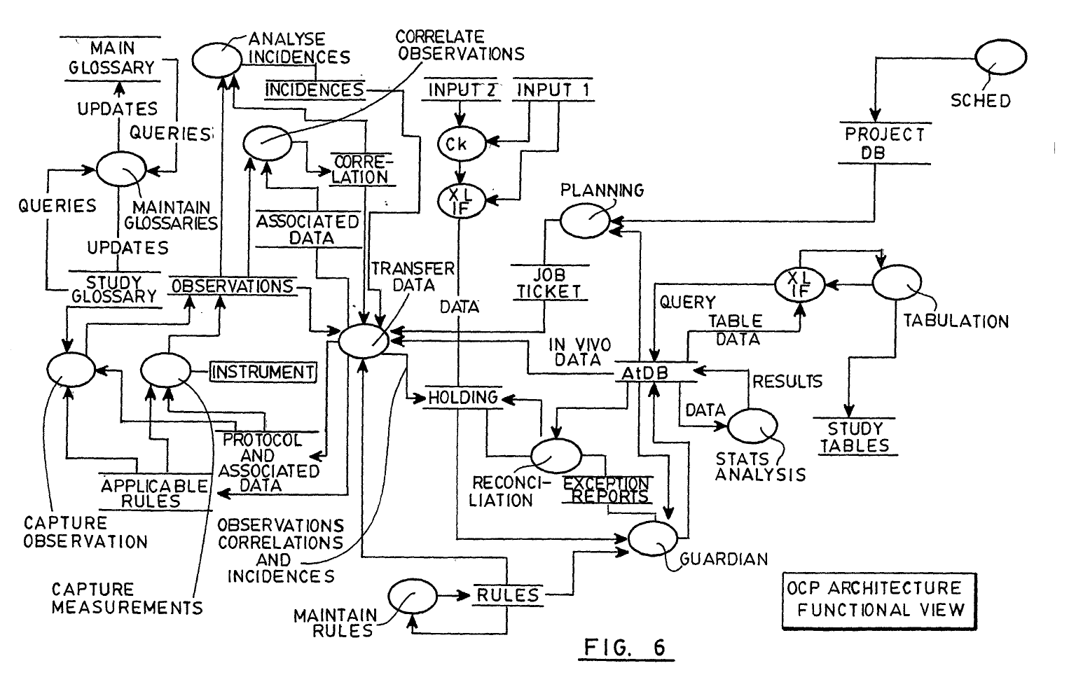

FIG. 6 presents the architecture of the system of the present invention from a functional perspective indicating data flows and processes.

Each of these elements will be detailed hereinafter.

### OCP PLANNING STATION

The Planning Station 11 is preferably a software-only package that is intended to run on any standard computer supporting a network connection. This station is used by the study planning and scheduling group to prepare, based on the study protocol, the various work packages (called Job Tickets) that are to be downloaded to the primary capture tools in support of study activities. The Planning Station 11 shares its information across the facility's local area network (LAN) through a central database that interconnects all Stations, except for the primary capture tool 15. The database is also bridged to the Data Management database 19 through the various stations and the facility's LAN or WAN communications (dial-up dedicated services or Internet access).

The Planning Station will allow an authorized user to define an observation lexicon, associate a lexicon with an acquisition cycle (i.e. Time Point and data collection task), prepare the list of authorized technicians (based on the training records and the task at hand) and establish the list of Test Systems affected by the acquisition cycle.

### OCP DOWNLOAD STATION

The Download Station 13, again preferably a software package running on a standard computer, is equipped with a docking port for the primary capture tool. Once logged in and authenticated on the Download Station, the technician selects from a list of available tasks prepared for the current acquisition cycle on the specified study. With the primary capture tool docked, the required information such as authorized technicians, list of Test Systems and previous acquisition cycle values is transferred from the database to the primary capture tool's own on-board database. Once the download is complete, the technician logs off the Download Station and proceeds to acquire data in the Clinic or Investigator's office through the now-offline primary capture tool.

### PRIMARY CAPTURE TOOL

The primary capture tool is the principal component of the system of the present invention. It consists preferably of a Palm-size PC running Windows CE™ and proprietary software. While each observation and or measurement task which can be accomplished with the present invention requires specific-to-task software modules, the primary capture tool also offers some across-the-board functions. For the Clinical Trials market for example, these standard functions include:

a digital signature module allowing the Investigator-of-record to review and confirm the content of the Case Report Form and, through encryption techniques, apply a digital signature to the document and force future changes to be audited. Any future change will automatically remove the investigator's signature;

An automatic audit trail module that captures the time and nature of any change to any committed observation or measurement as well as the ID of the user making the change and a reason for the change. The audit trail will also capture the action that caused the data record to be modified; and

A standardized set of capture tools that can be tailored, through data definitions, to support most Clinical Trial requirements. Custom capture tools are possible but usually unnecessary. The use of standard tools significantly reduces the preparation time needed to field the acquisition units.

### UPLOAD STATION

The Upload Station 17 is the final link in the data capture chain. Like the other LAN-based components of the system of the present invention, the Upload Station is preferably a software package that runs on standard computers. Its function is to recover the trials data captured on the primary capture tool and prepare the primary capture tool for its next capture cycle.

Beyond validating the Investigator-of-record and the Job Ticket, the Upload Station monitors the collected data for any Sponsor-specified data excursions. If any such excursions are detected, the investigator will be asked to confirm the accuracy of the data. This greatly reduces the time required to deal with out-of-range and unusual data queries while ensuring maximum integrity of the data collected and the collection process itself.

Once the uploaded data is cleared of any ambiguities, the Upload Station will effect the transfer of the data to the Data Management database and update the Job Ticket's status within the OCP database.

### Tabulation and Reporting

The system of the present invention is a data capture system and as such relies on the commercial Data Management System to which it is interfaced to provide tabulation and reporting features.

### Other Considerations

While the various subsystems of the system of the present invention have been presented as interconnected applications running from separate machines, the implementation need not be thus. In fact, it is possible to run all the LAN/WAN based functions from a single machine to which the primary capture tool's docking station is connected. Conversely, the functions can be run through wide area technologies such as dial-up networks and the Internet. The topology of any given implementation is more a matter of overall size of the operation and effective use of resources than any particular constraints associated with the system's design.

For those laboratories not wishing to make use of the features provided by commercial Data Management Systems or not currently in possession of such systems, a companion product to the system with which it is fully integrated and from which observations and measurements can be tabulated is also contemplated.

### System Functionality

The OCP supports the definition, acquisition and transfer of Case Report Form data. This data will include clinical observations made by the investigator as well as basic physical parameters and vital signs with either user input or direct connection to electronic instruments (preferably via EIA RS-232-C serial communication with ASCII encoding).

The OCP will also address particular study needs with enhanced sensor connectivity allowing for the direct connection of low-level sensors such as temperature, pressure, ECG and EKG, always maintaining the data capture focus of the system.

In use, a user will initiate an observation cycle by logging on to the Download Station and, after authentication, transfer, from the AtDB, the required Protocol and associated data elements. Once the transfer is complete, the observation cycle is accomplished stand-alone without any further support from the general computing environment, including the network. The observation cycle will be closed with the transfer of the observations from the primary capture tool to the holding database which is designed to accept AtDB style data records. Each transfer will trigger a Guardian verification and AtDB load cycle through the use of the Upload Station. In operation, the architecture will support, through programmed execution, the collection of observations and measurements.

It is intended that all observations and measurements be captured through the use of programmed user interactions with the primary capture tool. However in order to provide the flexibility required to quickly adapt to client requests for peculiar data captures and one time only data captures, the architecture of the present invention will also support the input of observations through the use of double entry forms and an interface called XLIF.

Reference will be now be made to FIG. 6, where the functional architecture of the system of the present invention, the <<transfer data>> function provides all necessary bi-directional interfaces between the User and the system. These interfaces include: User and Assignment authentication, Protocol data transfer, Associated data transfer, observations transfer, rules and glossary transfers. <<Capture observations>> provides the necessary User interface to support observation cycle specific capture of human observations driven by observation cycle specific glossaries and protocol requirements. <<Capture measurements>> (primary capture tool) will, under similar constraints to <<capture observations>>, collects measurements directly from electronic instruments connected via special-to-purpose interface cards, <<Correlate observations>> and <<Analyse incidences>> represent basic analyses that might be carried out concurrently (primary capture tool) within the observation cycle on the same computer or once the observation cycle is completed (UpLoad Station) and using a different computer. The <<Maintain glossaries>> (Planning Station) is a function that allows the User to add, modify and/or delete, under the constraints of Government regulations, the vocabulary used to describe the observations made in the course of an observation cycle. Finally, the <<Planning>> function (Planning Station) allows the user to derive job tickets (data collection tasks) from the production planning system.

The system according to the present invention is a highly portable hardware/software system specifically designed to meet the needs of technical staff involved in the collection of data in closely regulated industries such as drug development and air transport services to the public.

While these markets are supported by existing data management systems, the system is according to the Applicant, unique in its focus on the acquisition portion of the data management process. This narrow focus allows the system to benefit from single purpose optimizations that are impractical in larger multi-function implementations.

Once collected, the data can be transferred to any of the popular data management systems currently on the market. In the case of Clinical Trials, this means any SQL-92 compliant database manager or SAS solution. By providing specific gateways to commercial data management systems, the system of the present invention makes it possible for the end user community to improve their data capture quality and efficiently without incurring the time and expense associated with acquisition, training and validation of an entirely new system. Rather the validation burden is limited to the confirmation of acquired measurements and observations and the training, which is directed at the technical staff, is highly visual with direct programmatic support for industry “best practices”.

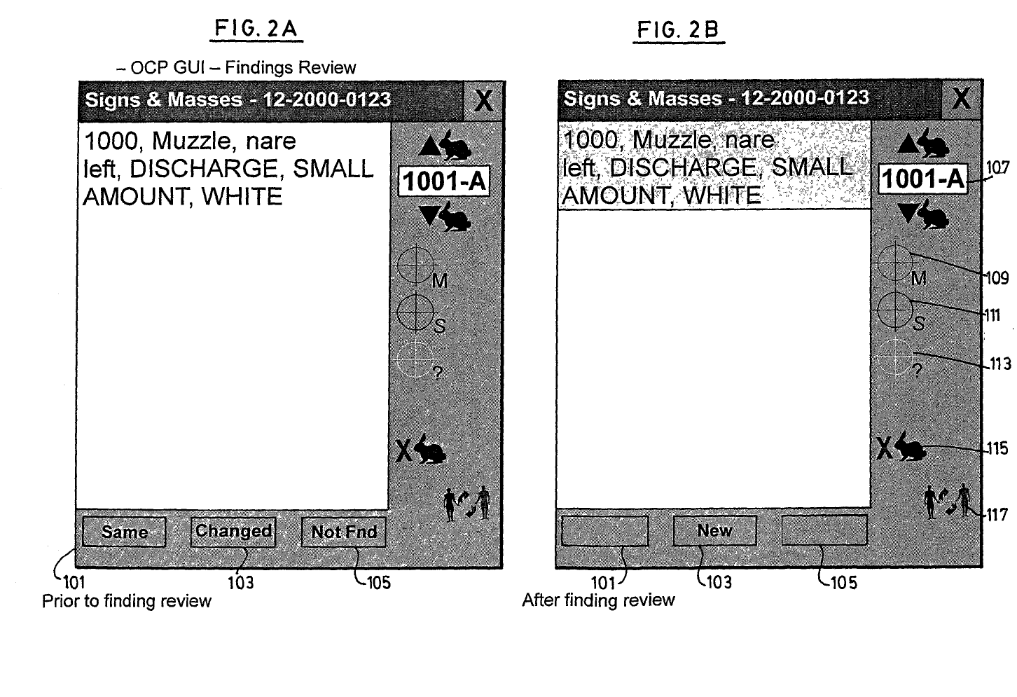

The use of traditional (e.g. Windows®) graphical user interfaces (GUI) within the data capture environment is not new, nor is the use of specific graphical presentations for navigation of the capture process. The system's GUI shown in FIGS. 2a, 2b, 3a, 3b, 4a, 4b, 5a, 5b is however novel in that it uses the presentation of drawings coupled to specialized software capture “tools” as its exclusive interface to the user. This approach is critical to the architecture's goal of simplifying, streamlining and improving the overall effectiveness of the process automation provided by the system.

In the context of a clinical trial, the GUI include as elements:

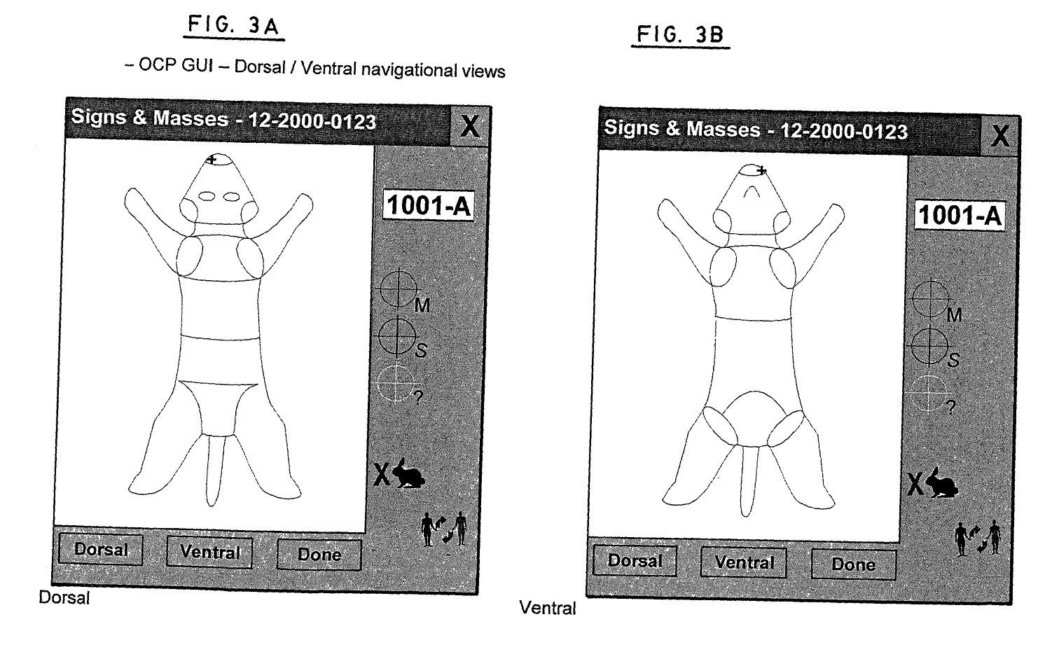

The use of two sided (ventral and dorsal) images to provide localization and lexical validation of each observation made (cf. FIG. 3). This contributes both to the quality (accuracy) of the observation and the intuitiveness of the system. In the drug research setting, this two-sided presentation ensures that simple mistakes such as lateralization (confusing left with right or vice-versa) and use of abdominal finding codes for chest observations are eliminated. In the large equipment maintenance setting, assembly drawings at multiple levels of detail ensure that the correct item is being inspected and both measured and observed using the correct tools. This is expected to reduce the incidences of incorrect part substitutions and inappropriate maintenance actions due to poor training or recent changes to procedures.

By limiting the user's opportunities for error (through the use of pick lists and visual localization), subsequent revisions of the captured data can focus on the analysis and interpretation of the findings rather than substantial quality reviews aimed at confirming that the correct capture protocols, procedures and tools were used. In the drug development application this could reduce data review from three months to two days in the case of most mid-sized studies (studies with an average duration of 6 to 12 weeks).

At an operational level, the use of Test System schematics and application-specific lexicons force the capture operators to provide only “valid” observations and measurements. The required meta information (e.g. date/time stamp of captured data, ID of technician and instrument used to capture data as well as confirmation that the technician performing the operation is currently qualified) is all integrally associated to the data record by the OCP. This has important implications for both the quality of the data captured as well as the overall cost of executing studies given that data verification and correction times are drastically reduced over traditional capture methods.

Interface elements:

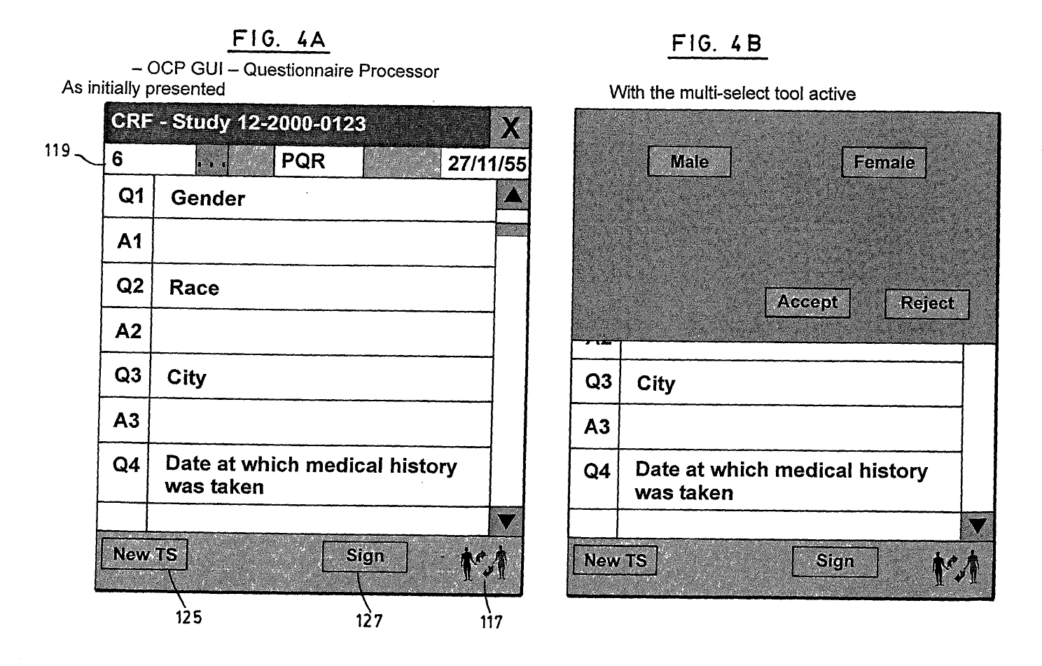

The OCP functions in one of two basic modes with respect to its Graphic User Interface. FIGS. 3 and 4 present the “specialized tool” mode, which incorporates the two-sided graphic that was previously described. This mode is considered a specialized mode as each implementation must be programmed to operate with its graphics. FIG. 2 presents the “findings review” function of the “specialized tool” mode. This function tabulates the findings collected in the previous observation cycle. The user is required to review each finding and record whether it is present and unchanged 101, present and changed 103 or not found 105. Reviewed findings are highlighted (shaded in FIG. 2b). When all findings for a Test System have been reviewed, the review function relabels these command buttons (101, 103, 105) to allow the user to record new observations.

FIGS. 2 and 3 present the “new findings” editor which incorporates the two-sided graphic presentation. With this function enabled, new observations are recorded by tapping the graphic in the area that localizes the site of the finding on the Test System. This action invokes a site specific list of detailed locations from which the user is to select. Once the detailed site is selected, a dialogue tool appears and guides the user through the selection of a finding and appropriate modifiers. The level of detail associated with each observation is established at the time an observation lexicon is defined (using the Planning Station). This detail is particular to each finding for each detailed site of each location.

Beyond the essential collection presentation, the “specialized tool” mode includes a number of support controls:

The Test System selector 107 allows the user to navigate among the pre-set list of Test Systems required to be observed in this cycle. The selector includes controls to select the Next Test System or the Previous Test System. Test Systems can be randomly selected by tapping the current Test System field and selecting from the pull-down list that is presented;

A set of three controls 109, 101, 113 are used to define the specific type of observation being made (i.e. location independent observation, location dependant observation and edit tapped observation respectively);

The Critical Observation tool 115 allows the user to capture critical observations related to Test Systems that are not currently in the Test System selector list; and

The User Swap 117 which allows the user-of-record to be changed in the field.

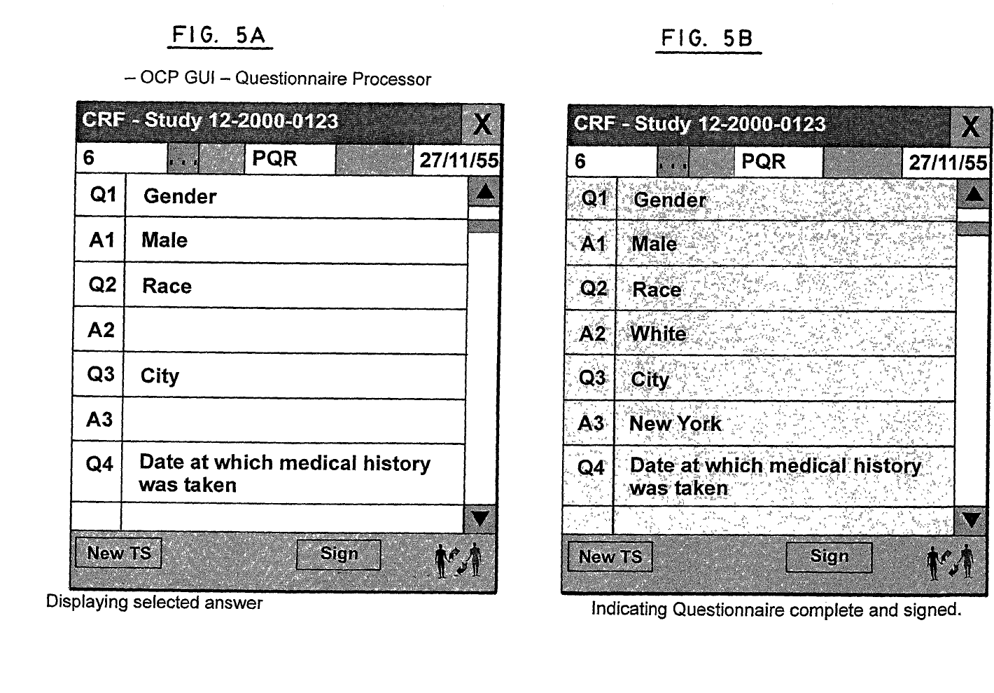

FIGS. 4 and 5 present the Questionnaire Processor mode of the system of the present invention.

This mode is considered the base mode of operation of the system as it requires no “special to task” programming (assuming the required capture tools exists) and can be configured for operation by the users. As its name implies, this mode uses a questionnaire metaphore (i.e. series of questions and answers on a linear form) to guide the user through observations. Each question posed (as presented in FIG. 4) has associated with it a capture tool that is configured with the list of allowable answers. In operation, the user taps the question and is presented with a capture tool (in FIG. 4, the user tapping the word “Gender” would result in the multi-select tool displaying the options “Male” and “Female”) from which he would make his selection.

Capture tools allowing dates, times, numeric values, comments and selection from lists are all presently included in the Questionnaire Processor. As specific instrument interfaces are developed, tools will be programmed and included in the Questionnaire Processor. As with the “findings review” function, highlighting (shading in the drawings) is used to signify that a questionnaire is complete and has been electronically signed by the investigator-of-record.

Peripheral controls for this view include:

The Test System selector 119, 121, 123 which identifies the Test System to which the answers of the questionnaire apply. Navigation among the allowed Test Systems is achieved by tapping the ellipsis button 119 and selecting a Test System from the list presented;

The New TS control 125 allows the user to add a Test System to his list of allowed Test Systems. The availability of this control is determined by the user at the time the form is configured in the Planning Station. Once in the field, the function cannot be independently enabled or disabled;

The Sign control 127 is used by the investigator-of-record to mark the answers collected against a Test System as reviewed and set. Further changes made to these records will be administered by the system's change control system (Audit Trail);

The User Swap 117 which allows the user-of-record to be changed in the field.

Database structure and other considerations

While the use of relational database technology in the storage and retrieval of information collected through manual and automated means is a generalized approach in most data processing environments, this technology inherently requires that the data being stored and retrieved be modeled as to its type, size and inter-relationships (meta data). By using a data abstraction model that reduces the data elements to their most simple expression (hence the use of the term “atomic” in describing the database), the need for modeling the data inter-relationships is removed from the database environment and placed within the data elements themselves. In effect, the traditional meta data is transformed into data. This has as a consequence that virtually any type of data can be captured by the system of the present invention and stored within the AtDB without the need of programming. It is this facility that allows the OCP to be retargeted from industries such as Drug Development to Aerospace to Financial Management and Insurance Claims processing without the need to reprogram or modify the database.

The elements of the database include:

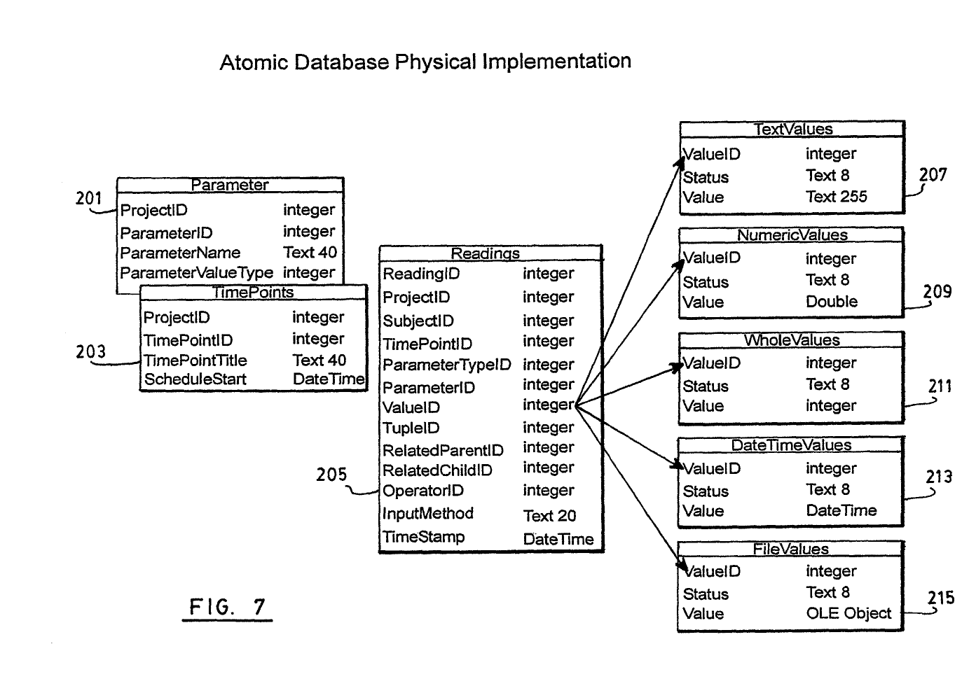

The use of a fixed data abstraction (see FIG. 7) that reduces any reading or observation made with the system of the present invention to a series of single element records that carry within them the rules for recreating their association with other records.

This obviates the need for the database management system to understand the nature of the information stored within it and, as a result, renders the database generic. Since the generic database need not be programmed, the system of the present invention can be tailored to a specific capture activity more rapidly by users than other systems that rely on programming resources to convert the data relationships into relational structures through data modeling techniques.

Database elements

FIG. 7 presents a physical implementation of the database within Microsoft Corporation's ADO™ data management environment. The elements include:

Parameter table 201;

TimePoints table 203;

Readings table 205;

TextValue table 207;

NumericValue Table 209;

WholeValue table 211;

DateTimeValue table 213; and

FileValue table 215.

The Parameter table 201 provides a User-specified name (ParameterName) for each data element stored in the readings table along with the necessary typing (ParameterValueType) to allow the system to correctly select the appropriate storage table.

For those cases where the information collected by the system is repetitive (e.g. similar data collected on repeat visits to a clinician or data collected at every preventative maintenance inspection of an aircraft), the TimePoints table is provided to allow the user to assign a name (TimePointTitle) and a schedule (ScheduleStart) to each occurrence of the data capture event.

The Readings table 205 holds all the information associated to a data element save for the actual value of the specific element. Given that the storage element is, in all cases, specific to the nature of the information held (i.e. picture, floating point number, integer value, text string), the readings table holds a pointer to the specific storage element (ParameterID) as well as a type indicator (ParameterTypeID) used to specify the storage element type.

The Readings table 205 holds an index to the TimePoints table 203 (TimePointID), which allows similar data elements (ParameterID/ParameterTypeID) to be differentiated on an occurrence basis.

The Readings table 205 maintains, through the use of pointer fields (RelatedParentID and RelatedChildID), the linkages necessary to reconstruct the associations between itself and other Readings records. These fields hold, as data, the information normally understood to be the database's meta data. The fields form a linked list.

The Readings table 205 maintains information relating to the identity of the person making the observation (OperatorID), the time at which the observation was made (TimeStamp) and the manner in which the observation was made (InputMethod) as part of the data management and security system.

Each of the data element tables (i.e. TextValue 207, NumericValue 209, WholeValue 211, DateTimeValue 213 and FileValue table 215) is structured similarly in that they have an identifier field (ValueID) which serves to uniquely identify the value held and which is copied to the Readings table's ValueID field, a value field (Value) which holds the data element's value and a status field (Status) used by the system to determine the phase within the capture process each record is in currently. The Value field is typed according to the data element type it holds.

Although the present invention has been explained hereinabove by way of a preferred embodiment thereof, it should be pointed out that any modifications to this preferred embodiment within the scope of the appended claims is not deemed to alter or change the nature and scope of the present invention.

1. A system for the collection of observations comprising:
a planning station, for preparing a work package of observations to be collected;
a download station for downloading said work package to at least one primary capture tool, said primary capture tool being used to collect observations according to said work package; and
an upload station, for uploading said observations from said at least one primary capture tool.

2. A system according to claim 1, wherein said at least one primary capture tool is a hand-held device operating autonomously.

3. A system according to claim 2, wherein said at least one primary capture tool is provided with a graphical user interface, said graphical user interface enabling the capture of valid observations and measurements.

4. A system according to claim 3, wherein said graphical user interface includes an image of a target for which observations are being collected and a pick list, so that when a portion of the image of the target is selected by a user, said pick list narrows the options available to the user to enter as an observation.

5. A system according to claim 4, wherein said pick list is established according to an application specific lexicon.

6. A system according to claim 1, wherein said system further includes a database, said database being implemented with an atomic data structure.

7. A system according to claim 6, wherein said atomic data structure comprises a fixed data abstraction, whereby an observation is reduced to a series of single element records that carry within said records the rules for recreating an association with another record.

8. A method for collecting observations, comprising the steps of:
downloading an application-specific work package established at a planning station to at least one primary capture tool;
collecting observations with said at least one primary capture tool using a graphical user interface; and
uploading said observations to an upload station.

9. A graphical user interface for use with a primary capture tool to collect observations of a target, said graphical user interface including a graphical representation of said target and a pick list, wherein when said user selects a portion of said graphical representation of said target, a pick list appears, thereby enabling said primary capture tool to collect valid observations and measurements.
